(19) United States
(12) Patent Application Publication
(10) Pub. No.: US 2004/0089242 A1
(43) Pub. Date: May 13, 2004

(54) Device intended for injecting a fluid into a system comprising a milk cup and a milk line

(76) Inventors: Albertino Bernardo M Verstege, Aalten (NL); Otto Theodorus J Zents, Lichtenvoorde (NL)

Correspondence Address: JACOBSON HOLMAN PLLC, 400 SEVENTH STREET N.W., SUITE 600, WASHINGTON, DC, 20004, US

(21) Appl. No.: 10/332,977

(22) PCT Filed: Jul. 25, 2001
(86) PCT No.: PCT/NL01/00574

(30) Foreign Application Priority Data
Jul. 25, 2000 (NL) 1015803

(51) Int. Cl. A01J 5/04

(52) U.S. Cl. 119/14.47

(57) ABSTRACT

A device for injecting a fluid into a system comprising at least one milk cup and one milk line connected to the milk cup for discharging milk from the milk cup, the milk cup being provided with an open end for receiving a teat of an animal in the milk cup, the device being provided with an injector for injecting, at an injection position, the fluid into the system, the device being further provided with a closing valve for closing the milk line during injection, the closing position being at a position such that the injection position is located between the open end of the cup and the closing position, characterized in that the closing valve is designed to be closable while being driven by the fluid to be injected.

The invention relates to a device for injecting a fluid into a system comprising at least one milk cup and one malk line counected to the milk cup for discharging milk from the milk cup, the milk cup being provided with an open end for receiving a teat of an animal in the milk cup, the device being provided with an injector for injecting the fluid into the system at an injection position, the device being further provided with a closing valve for cloing off the milk line during the injection of the fluid, the closing position being at a position such, that the injection: position is located between the open end of the cup and the closing position.

Such a device is known per se.

For the pneumatic milking of cows, a system is used comprising, generally, four cups, each connected to a milk line through which the milk is discharged. Via a collection unit, the four mil lines lead to a milk discharge channel. The unit of four cups with lines is also called the cluster. During milking, the teats of a cow are received in the open ends of the cups. A pulsating vacuum source connected to the cups generates the milk flow. When the millking of a cow has been completed, the pulsating vacuum is removed and the cups are detached from the teats to be fitted to the teats of another cow which has not yet been milked. As pollution of the cups—most often of a bacteriological nature—can lead to infections being transmitted from one cow to the other, the cups are cleaned after the milking of each cow. To this end, the inside of the cup is sprayed with a cleaning medium and sometimes rinsed with water and/or dried with compressed air. A branch of the milk line with a supply line connected thereto, through which a cleaning medium, water and/or compressed air, can be supplied, is provided with an injector which opens owing to the high pressure of the supplied media for injecting the fluid and cleaning the cup. The pressure of the supplied cleaning media, hereinafter; the fluid, is controlled separately. To prevent the possibility of the fluid ending up, via the milk line, in the milk, the cluster is brought in a position in which the fluid, under the influence of gravity, can drip from the cup. In practice, this means that the cluster is suspended upside down in regard to the position of the cluster during milking. The above-described device and method is known from EP 0543463.

An elaboration of this device and method is known per se.

To shorten the time of the transfer of the cluster from a milked cow to a cow to be milked, it is desired to already inject the fluid before the cluster is kept upside down.

It is also desired, after milking, to disinfect the teats of the animals and/or to treat them with a liquid. This is done by injection of a fluid into the milk cups when the milk cups are still connected to the teats. Therefore, during this operation the milk cups are also injected with fluid, even before they are brought in an upside down position. To prevent fluid from flowing into the milk line under the influence of gravity, a closing valve is provided to close the milk line off during injection. This valve is controlled separately.

A disadvantage is that when the line controlling the closing valve is not properly connected, the closing valve does not close when fluid is injected into the system of milk cup and milk line.

Moreover, the lines for controlling the valves entail extra costs for the production and purchase of such devices.

Another disadvantage of this device is that each milk cup is provided with our lines, viz. a milk line, a vacuum line, an injection line and a line for controlling the closing valve. This renders the cluster, difficult to handle as it is with the four milk cups and all these lines, inconvenient and extra cumbersome in use.

An object of the invention is to provide a device which meets the disadvantages mentioned.

The object mentioned has been achieved with the device according to the invention, which is characterized in that the closing valve is designed to be closable while being driven bathe fluid to be injected.

An advantage is that a situation wherein the fluid is injected and the valve does not close off the milk line is virtually excluded. Hence, the risk of milk and fluid mixing is strongly reduced, or excluded.

Another advantage of this device is that the injection line and the line for controlling the closing valve coincide. Thus, the number of lines per milk cup is reduced in relation to a known device for injecting a fluid into a system comprising a milk cup and a milk line. The convenience and ease of manipulation of the cluster have improved in comparison to the known cluster.

Further elaborations of the invention are described in the subclaims and will be clarified hereinafter on the basis of an exemplary embodiment with reference to the following figures.

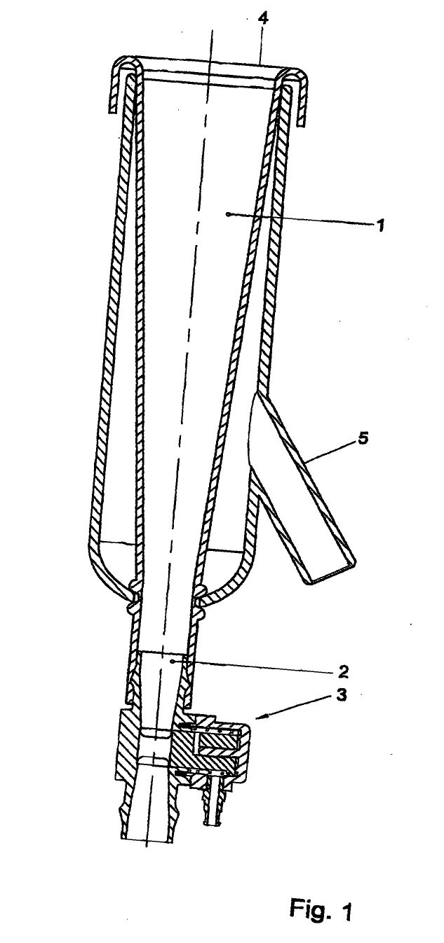

FIG. 1 shows a cross section of a device for injecting a fluid into a system comprising at least one milk cup and a milk line connected to the milk cup, the device being provided with a closing valve;

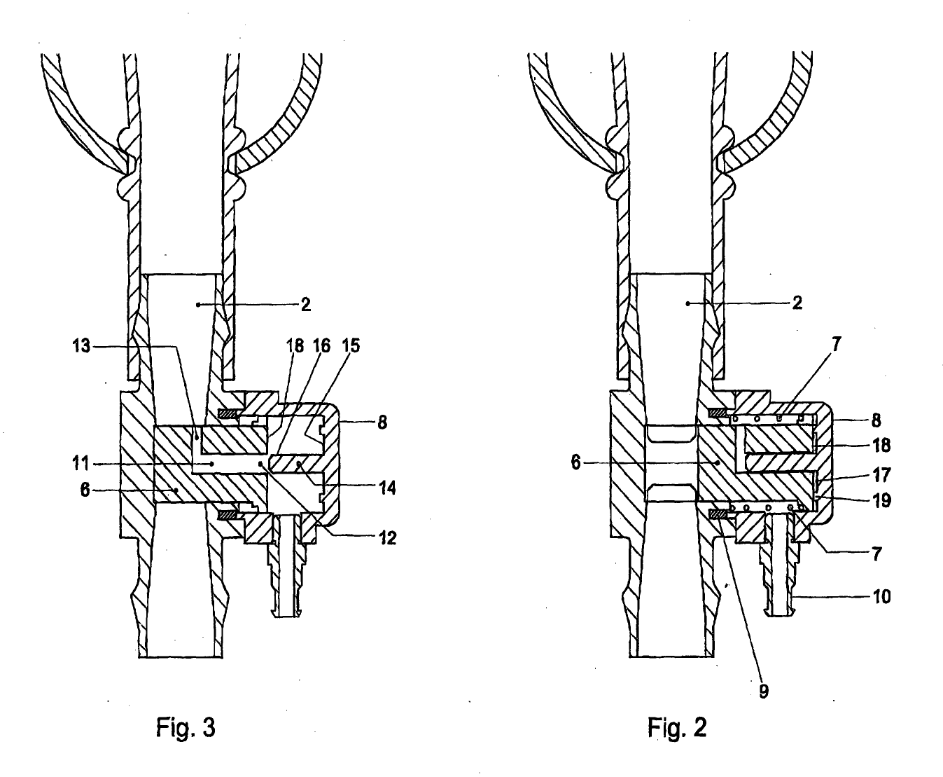

FIG. 2 shows a cross section of the dosing valve shown in FIG. 1, with a movable part in the first position;

FIG. 3 shows a cross section of the closing valve shown in FIG. 2, a movable part being in the second position.

FIG. 1 shows a cross section of a device for injecting a fluid into a system comprising at least one milk cup 1 and a milk line 2 connected to the milk cup 1, the device being provided with a closing valve 3. The milk cup is provided with an open end 4 for receiving a teat of an animal. To the milk cup 1, a vacuum line 5 is connected with which a vacuum, mostly pulsating, is created to trigger the milk flow and keep it going. In FIG. 1, the closing valve 3 is in the first position, in which the valve does not close off the milk line. In relation to FIG. 1, FIG. 2 shows an enlarged picture of the cross section of the closing valve. The closing valve is provided with a movable part, in this case a piston 6, which is kept in the first position by a spring 7. In this position, the movable part does not close off the milk line. The closing valve is also provided with a housing 8 in which the piston 6 is movably disposed between the first and the second extreme position. The closing valve is provided with a sealing 9 connected to the piston, which sealing seals a space between housing and piston, contiguous to the milk line. The housing 8 is provided with an inlet 10 for the fluid to be injected. When the piston 6 is in the first extreme position, a minimal space 17 is present between a free end 18 of the piston 6 and an inner wall 15 of the housing 8, situated opposite this free end 18. In a special embodiment, small stop blocks 19 are disposed in the space 17 for defining the minimal space 17. In the piston 6 and/or the inner wall 15 of the housing 8, a recess (not shown) is arranged, which is positioned such that in the first extreme position the inlet 10 is in fluid communication with the minimal space 17. With the fluid to be injected, pressure is built up within the housing 8 so that piston 6, while being driven by the fluid to be injected, is moved from the first position to the second position. In this second position, the milk line is closed off as shown in FIG. 3. The piston 6 is further provided with an outflow channel 11. The outflow channel 11 comprises an inflow opening 12 and an outflow opening 13. The inflow opening 12, at least when the piston is in the second extreme position, is in fluid communication with the inlet 10. The outflow opening 13 is positioned such that it is in fluid communication with the milk line when the piston 6 is in the second extreme position. When the piston is in this second extreme position, the fluid to be injected is injected into the milk line.

In FIG. 2, the situation is shown wherein the piston 6 is in the first extreme position. In that case, the inflow opening 12 is closed off from the inlet 10. To that end, the housing is provided with a pin 14 extending from an inner wall 15 of the housing 8. The free end 16 of the pin extends through the inflow opening 12 into the outflow channel 11 when the piston is in the first extreme position. In this first extreme position of the piston 6, the outflow opening 13 is also closed off from the milk line 2. When the piston is in the second extreme position, the pin 14 is entirely outside the outflow channel 11.

In this example, a part of the outflow channel is oriented parallel to the milk line so that a fluid flow in this part extends in the direction of the milk cup. This has as an advantage that the milk cup can be cleaned well and/or the teats can be treated well with a liquid. The piston 6 is movable between the first and the second position in a direction perpendicular to an axial direction of the milk line 2 at the closing position. As a result, the resistance to be experienced of a milk flow against the movement of the piston from the first to the second position is minimal. The pin 14 can, at its free end 16, be rounded. This is shown in FIG. 3. When the housing is filled with fluid to be injected, the piston moves from the first position in the direction of the second position. Before the piston 6 has arrived at the extreme second position, a marginal fluid communication is created between the outflow channel 11 and the inlet 10, due to the pin 14 being rounded and/or the reduction provided at the inflow opening 12. As a result, the outflow channel 12 fills with fluid before the fluid can flow out of the outflow opening 18. The pressure thus exerted on the piston 6 is suddenly strongly increased, so that the piston 6 moves in an accelerated manner in the direction of the second position.

In a special embodiment, the piston 6 is provided with a flat piston head surface. For a good closure, the inner wall of the milk line against which the piston head surface abuts in the second position, is also flat. When the piston 6 is in the extreme first position, the piston head surface can be in line with the inner wall of the milk line such, that the piston head surface and the inner wall of the milk line are virtually in one plane. In this embodiment, the milk flow experiences hardly any resistance from the inner wall of the milk line. Furthermore, there are no abrupt differences in relief which may lead to accumulation of dirt. Near the piston, the inner wall of the milk line can comprise a constriction. As a result, when the piston is in the extreme second position, there are less sharp angles present in which, possibly, dirt can accumulate. With a view to uniform assembly of the device, the part of the outflow channel in which the pin extends in an extreme position can be displaced relative to an axial axis of the piston. Also the housing, the piston and the milk line can be provided with mating guiding parts being geared to one another such that the piston fits uniformly onto the milk line.

In an advantageous embodiment of the device, the inlet is provided with an inlet piece connected to the inlet for supply of the fluid to be injected, the inlet piece being at least partly parallel to the milk line. Thus, the manageability of the cups and the lines connected to the cup is improved as compared to the known cluster. At the outflow opening 13, the outflow channel 11 can be provided with a spraying device. The corners of the outside of a housing can be rounded, so that neither milker nor animal can be injured upon contact with the housing. Furthermore, the closing valve and the injector can be made of wholly demountable design, thus making inspection and replacement of parts, as well as cleaning, a simple operation.

A general advantage of the device according to the invention is that the device can be made of compact design. Another advantage is that there is no risk of uneven wear of a closing valve and an injector, as the closing valve and the injector are made from the same parts. As a result, the inspection and repair time can be limited. Furthermore, the costs of material can be reduced. Additionally, the device can be such, and the materials for the piston and housing can be selected such that, even when, in time, the spring weakens, the milk line is closed off by the piston when, unintentionally, fluid is supplied. Other variants of the described device, based on the inventive concept of the invention, are understood to fall within the scope of the invention.

1. A device for injecting a fluid into a system comprising at least one milk cup and one milk line connected to the milk cup for discharging milk from the milk cup, wherein the milk cup is provided with an open end for receiving a teat of an animal in the milk cup, the device being provided with an injector for injecting the fluid into the system at an injection position, the device being farther provided with a closing valve for closing off the milk line during injection of the fluid, the closing position being at a position such that the injection position is located between the open end of the cup and the closing position, characterized in that the closing valve is designed to be closable while being driven by the fluid to be injected.

2. A device according to claim 1, characterized in that the closing valve is provided with a movable part which is movable between a first and a second extreme position, wherein, in the first extreme position, the movable part does not close off the milk line, and, in the second extreme position, closes off the milk line at the closing position.

3. A device according to claim 2, characterized in that, in use, the movable part is moved from the first position to the second position while being driven by the fluid to be injected.

4. A device according to claim 2 or 3, characterized in that the closing valve is further provided with a spring which pushes the movable part in the direction of the first position.

5. A device according to claim 3 or 4, characterized in that the movable part is provided with a piston.

6. A device according to clam 5, characterized in that the closing valve is provided with a housing in which the piston is received so as to be movable between the first extreme position and the second extreme position.

7. A device according to claim 6, characterized in that the closing valve is provided with a sealing contiguous to the piston, which sealing seals a space between housing and piston contiguous to the mil line.

8. A device according to claim 7, characterized in that the housing is provided with an inlet for the fluid to be injected.

9. A device according to any one of claims 6-8, characterized in that in the first position, a minimal space is present between a free end of the piston and an inner wall of the housing located opposite this free end.

10. A device according to claim 9, characterized in that small stop blocks are present in the space for defining the space.

11. A device according to claim 9 or 10, characterized in that the piston and/or the inner wall of the housing is provided with a recess, the recess being positioned such that in the first extreme position the inlet is in fluid communication with the minimal space.

12. A device according to claim 8, characterized in that the piston is provided with an outflow channel extending in the piston, the outflow channel being provided with an inflow opening which, at least in the second extreme position, is in fluid communication with the inlet, the outflow channel being fiber provided with an outflow opening, the outflow opening being positioned so as to be in fluid communication with the milk line when the piston is in the second extreme position.

13. A device according to claim 12, characterized in that in the first extreme position, the inflow opening is closed off from the inlet and/or the outflow opening is closed off from the milk line.

14. A device according to claim 13, characterized in that the housing is provided with a pin extending from an inner wall of the housing, a free end extending through the inflow opening into the outflow channel when the piston is in the first extreme position and the pin being located entirely outside the outflow channel when the piston is in the second extreme position.

15. A device according to any one of claims 12-14, characterized in that a part of the outflow channel is oriented parallel to the milk line, a fluid flow direction extending in this part in the detection of the milk cup.

16. A device according to any one of claims 5-15, characterized in that the piston is movable between the first and he second position in a direction directed perpendicularly to an axial direction of the milk line at the closing position.

17. A device according to any one of claims 14-16, characterized in that a free end of the pin is rounded.

18. A device according to any one of claims 14-17, characterized in that the part of the outflow channel in which the pin extends in the extreme position, is displaced in relation to an axial axis of the piston.

19. A device according to any one of claims 12-18, characterized in that the outflow channel at the inflow opening is provided with a reduced portion.

20. A device according to any one of claims 5-19, characterized in that the piston is provided with a flat piston head surface.

21. A device according to any one of claims 5-20, characterized in that a piston head surface of the piston and an inner wall of the milk line against which the piston head sconce abuts are virtually in one plane in the extreme first position.

22. A device according to any one of claims 6-21, characterized in that the inner wall of the milk line near the piston comprises a restriction.

23. A device according to any one of claim 6-22, characterized in that the housing, the piston and the milk line are provided with mating guiding parts, such that the piston fits uniformly to the milk line.

24. A device according to any one of claims 8-23, characterized in that the inlet is provided with an inlet piece, connected to the inlet or supplying the fluid to be injected, the inlet piece running, at least partly, parallel to the milk line.

25. A device according to any one of claims 12-24, characterized in that the outflow channel is provided with a spraying device at the outflow opening.

26. A device according to any one of the preceding claims 6-25, characterized in that the outside of the housing is provided with rounded corners.

27. A device according to any one of the preceding claims, characterized in that the closing valve and the injector can be wholly disassembled for inspection and replacement of parts as well as for cleaning.
